(19) United States
(12) Patent Application Publication
(10) Pub. No.: US 2016/0000116 A1
(43) Pub. Date: Jan. 7, 2016

(54) Animal Feed Product and Methods For Its Preparation

(71) Applicant: James Allen Easterwood, Rogers, TX (US)

(72) Inventor: James Allen Easterwood, Rogers, TX (US)

(21) Appl. No.: 14/791,192

(22) Filed: Jul. 2, 2015

Related U.S. Application Data
(60) Provisional application No. 62/106,137, filed on Jan. 21, 2015.
(60) Provisional application No. 62/020,895, filed on Jul. 3, 2014.

(51) Int. Cl. A23K 1/00; A23K 1/02; A23K 3/00; A23K 1/14; A23K 1/16; A23K 1/18

(52) U.S. Cl. CPC A23K 1/004; A23K 1/1603; A23K 1/1631; A23K 1/164; A23K 1/1813; A23K 3/00; A23K 1/14; A23K 1/02; A23K 1/1643

(57) ABSTRACT

An animal feed product comprised of kernels of grain with an overcoat wherein the overcoat is comprised of substances that are valuable in ruminant nutrition or ruminant behavior.

This application claims the benefit of U.S. Provisional Application No. 62/106,137, filed Jan. 21, 2015, and U.S. Provisional Application No. 62/020,895, filed Jul. 3, 2014.

### FIELD OF THE INVENTION

The invention relates to an animal feed product and methods for its preparation. Specifically, the invention relates to an animal feed product that is useful in the feeding and nutrition of ruminant animals. In one of many possible applications, the animal feed product may be used to feed animals in the phylogenic family Cervidae.

### BACKGROUND

Preparation of rigid animal feed blocks for use in the feeding and nutrition of ruminant animals is known in the art. Such rigid animal feed blocks may be comprised of a number of different feed materials, potentially including any one or more of the following: a protein source, a buffering agent, a drying agent, a sweetener, a binder, and various vitamins and minerals that are intended to improve animal health and aid in ruminant digestive processes. Rigid animal feed blocks traditionally contain a protein source such as ground grain, grain meal, or seed meal, rigidly bound together with added sweeteners, binding agents, and drying agents. For example, rigid animal feed blocks comprised of cottonseed meal, calcium carbonate, magnesium oxide, molasses, and various vitamins and minerals, all of which are rigidly bound together in block form, have been produced in large quantities in the past and used to feed domesticated ruminant animals.

While the specific constituent ingredients of rigid animal feed blocks have varied over the years, the common characteristic of all rigid animal feed blocks is that they are produced in a molded or extruded block form that is rigid or semi-rigid and is held together in block form by one or more binding agents. Although rigid animal feed blocks are frequently used for feeding domesticated ruminant animals such as cattle, they are not ideal for feeding all types of ruminants, and they especially are not ideal for feeding non-domesticated ruminants, such as deer, because the appearance and texture of the rigid animal feed blocks is dissimilar to the types of foods, including certain whole grains, encountered and eaten by ruminants in the wild or in rural areas, for example, field corn. Because rigid animal feed blocks do not have the same or similar appearance to the types of grains frequently encountered by certain ruminant animals in the wild or in rural areas, rigid animal feed blocks are less attractive and less palatable to certain ruminant animals than other food sources. Furthermore, such rigid animal feed blocks are not easily disbursed through certain types of animal feeding devices that are constructed to disburse whole grains, such as deer feeders that are designed to disburse corn to deer. A readily understood (though somewhat absurd) example that is illustrative of this problem would be a wildlife enthusiast, zoologist, or hunter trying to feed a rigid animal feed block to deer in a rural area using a conventional deer feeder that is designed to disburse corn or pelletized deer feed.

Pelletized animal feed used as feed for ruminant animals is also known in the art. For example, pellets comprised of various seed meals or grain meals mixed with sweeteners and various grain refining by-products have been produced in the past. Other types of pelletized animal feed have vitamins and minerals contained within the pellets for optimizing animal growth. Commonly these types of pelletized animal feeds are produced as small pellets containing processed grains, grain meal, or other protein sources along with other ingredients such as sweeteners and drying agents. Often, though not universally, pelletized animals feeds are produced and sold in the shape of small, dry or semi-dry cylindrically shaped pellets or small, roughly spherically shaped pellets. Although pelletized animal feed has been used to feed non-domesticated ruminants with some level of success, including the feeding of pelletized deer feed to deer through standard deer feeders that are traditionally designed to disburse corn, such pelletized feeds are not ideal because they lack the appearance and texture of whole grains that are found by ruminants in the wild and in rural areas. As a result, pelletized animal feed may be less palatable and less attractive to some ruminants, such as deer, than animal feed that is similar in appearance to the whole grains found in the wild or in rural areas, for example, field corn.

In an even less technologically complicated manner, animal feed comprised of cracked grains or grain meals mixed loosely with salt and desired vitamins and minerals, or mixed with attractants in powder or granular form, is also known in the art. This type of animal feed may be fed directly to animals through troughs or feeders or may be manually spread in certain locations where the animals congregate to feed on the loose mixture. This type of animal feed comprised of loosely mixed ingredients is not ideal for use in feeding ruminants, and is particularly unsatisfactory for feeding non-domesticated ruminants such as deer, because the loose salt, vitamins and minerals, or powdered or granular attractant chemicals, that are mixed into the feed may not be readily consumed by the animal eating the cracked grains or grain meals in the feed, and because the salt, vitamins, and minerals, or attractants in the feed may be washed or blown away from the feed by rain, wind or other weather events.

### SUMMARY OF THE INVENTION

The invention is directed to an animal feed product that provides more nutritional value, and potentially provides more vitamins and minerals, than traditional animal feed grains provide to ruminant animals, but retains inherent characteristics of the grains as they are found in wild or rural environments that make them palatable and attractive to many types of ruminant animals and that also make them easy to handle and disburse in certain types of animal feeder devices. The animal feed product disclosed herein is comprised of discrete whole or partial kernels of grain, or a mixture of discrete whole and partial kernels of grain, wherein the discrete whole or partial kernels of grain are wholly or partially coated with an overcoat that adheres to the outside surfaces of the kernels of grain. The overcoat may contain a sweetener, a binding agent, desired vitamins and minerals, a drying agent, a ruminant attractant, a preservative, an anti-molding agent, coloring, flavoring, or any one or more of the foregoing. The animal feed product hereby disclosed may be used to feed a wide variety of ruminant animals, including both domesticated and non-domesticated ruminant animals. The animal feed product may be used by hunters or wildlife enthusiasts in the feeding of deer and other non-domesticated ruminants through manual ground dispersion or through feeder devices. Methods for the preparation of the animal feed product are also disclosed.

The animal feed product is comprised of whole or partial kernels of grain that have been mixed with other substances that adhere as an overcoat to all or part of the outside surfaces of the discrete kernels of grain and thereby form an overcoat on the discrete kernels that wholly or partially covers the surface of the kernels. The overcoat deposited onto the surface of the kernels of grain may vary in composition depending upon the specific attributes desired for the animal feed product in terms of how it affects ruminant animals' diet or behavior. The animal feed product retains the appearance and shape of the kernels of grain as they would be found in a wild or rural environment because the multiple kernels of grain comprising the animal feed product remain individual, discrete, kernels, while the overcoat adhered to the surface of the kernels of grain supplements the nutritional value of the kernels themselves, or adds a ruminant attractant to the kernels, or does both, thereby improving the kernels of grain as a food source for ruminants in a manner that depends only on the substances selected for inclusion in the overcoat.

### BRIEF DESCRIPTION OF THE DRAWINGS

The following description is to be read in conjunction with the identified drawing figures that are included as a part of this patent application.

FIG. 1 is a side view of a whole kernel of grain that is wholly coated with an overcoat.

FIG. 2 is a side view of a whole kernel of grain that is partially coated with an overcoat.

FIG. 3 is a cross sectional view of a kernel of grain that is wholly coated with an overcoat.

FIG. 4 is a cross sectional view of a kernel of grain that is partially coated with an overcoat.

FIG. 5 is a side view of another embodiment of the invention in which a whole kernel of grain is partially coated with an overcoat.

### DETAILED DESCRIPTION OF THE DRAWINGS

The following detailed description is to be read in conjunction with the identified drawing figures that are included as a part of this patent application.

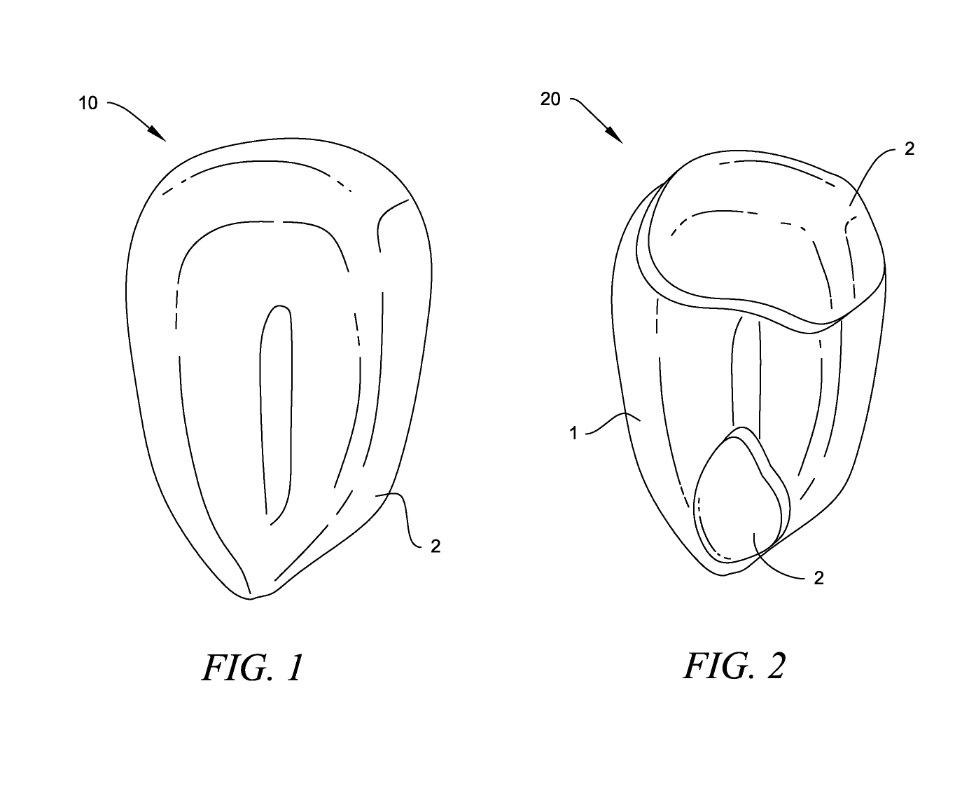

FIG. 1 is a side view of a first embodiment of the animal feed product 10 wherein the entire surface area of an underlying kernel of corn has been wholly coated with an overcoat 2.

FIG. 2 is a side view of a second embodiment of the animal feed product 20 wherein part of the surface area of a kernel of corn 1 has been coated with an overcoat 2, but the overcoat 2 does not completely cover the entire surface area of the kernel of corn 1.

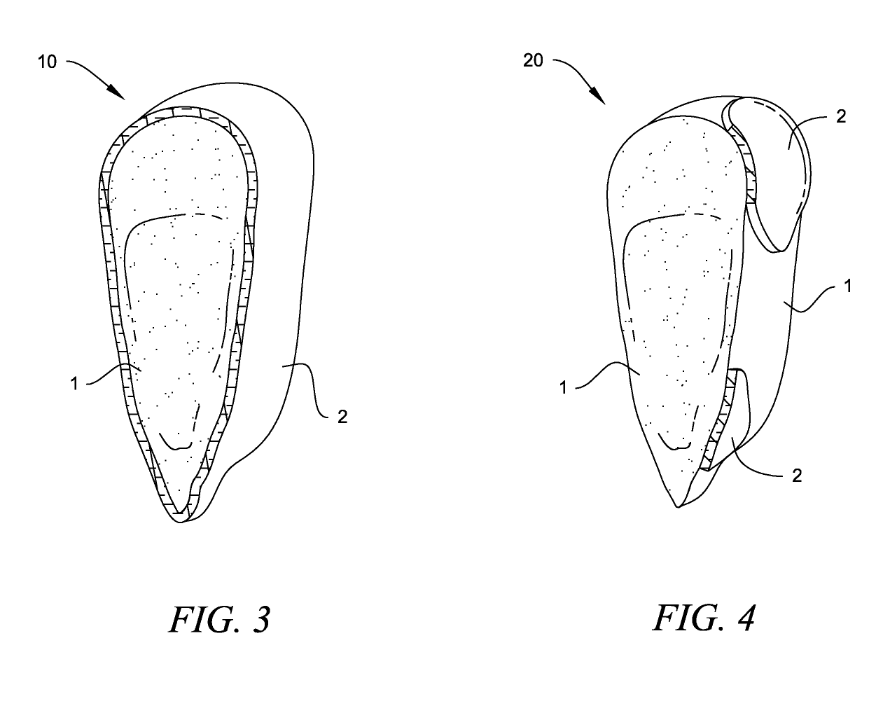

FIG. 3 is a cross sectional view of the first embodiment of the animal feed product 10 wherein the entire surface area of a kernel of corn 1 has been coated with an overcoat 2, with the cross sectional view showing the underlying kernel of corn 1.

FIG. 4 is a cross sectional view of the second embodiment of the animal feed product 20 wherein a part of the surface area of a kernel of corn 1 has been coated with an overcoat 2.

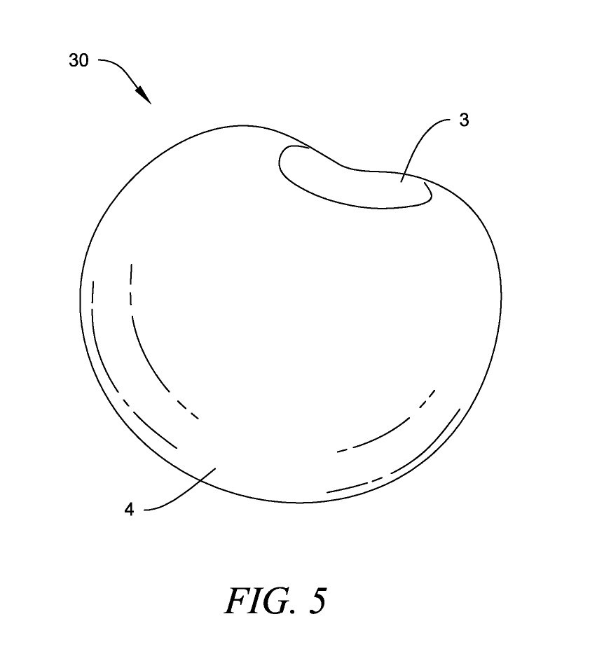

FIG. 5 is a side view of a third embodiment of the animal feed product 30 wherein part of the surface area of a kernel of soybean 4 has been coated with an overcoat 3, but the overcoat 3 does not completely cover the entire surface area of the kernel of soybean 4.

### DETAILED DESCRIPTION OF THE INVENTION

As set forth above, the animal feed product is comprised of multiple, discrete, whole or partial kernels of grain that are wholly or partially coated with an overcoat that is deposited onto the outside surface of each of the discrete kernels of grain such that the overcoat is bound to all or part of the outside surface of each of the discrete kernels of grain that make up the animal feed product. As also stated above, the overcoat adhered to the surface of the kernels may contain a sweetener, a binding agent, desired vitamins and minerals, a drying agent, a ruminant attractant, a preservative, an anti-molding agent, coloring, flavoring, or any one or more of the foregoing. The kernels of grain used in the animal feed product may be of one type of grain, or they may be a mixture of more than one type of grain. The animal feed product hereby disclosed may be used to feed a wide variety of ruminant animals, including both domesticated and non-domesticated ruminant animals.

It is preferable that the animal feed product is comprised of whole kernels of grain whose whole surface area is coated with an overcoat that provides additional nutritional value or additional ruminant attractant value while at the same time not compromising the overall shape and appearance of the whole kernels of grain. Although it is preferable for the animal feed product to be comprised of whole kernels of grain that are wholly coated with an overcoat that covers the entire surface area of each of the discrete kernels, in practice some of the kernels will be broken or cracked prior to, during, or after the preparation of the animal feed product, and therefore partial kernels of grain that have an overcoat also come within the scope of the invention. Regardless of which type (or types) of grain are used in the animal feed product, in practice the minimum size of the partial kernels of grain are limited on the low end such that the partial kernels may range anywhere from whole kernels down to partial kernels of grain that are at least two millimeters (2 mm) in diameter in any given direction. Furthermore, while it is preferable for the kernels to be wholly coated with the overcoat, in practice the kernels are sometimes only partially covered with the overcoat during the preparation of the animal feed product such that the overcoat on the kernels does not always cover the entire surface area of the discrete kernels of grain that make up the animal feed product. In such situations, the partial coverage of the kernels may vary, but the amount of coverage of the overcoat is limited on the low end such that the overcoat will cover anywhere from the entire surface areas of the kernels of grain down to five percent (5%) of the surface areas of the kernels.

The overcoat that is deposited on the surface of the individual, discrete kernels of grain is comprised of substances selected for their nutritional value or their ruminant attractant qualities, or both, while at the same time the discrete nature of the whole kernels of grain comprising the animal feed product is maintained, thereby preserving the inherent characteristics, including shape and appearance, of the kernels of grain that make the animal feed product more palatable and attractive to many types of ruminant animals. In order to preserve the shape and appearance of the discrete kernels of grain that make up the animal feed product, the overcoat on the surface of each of the kernels is no thicker than one centimeter (1 cm). The preferred thickness of the overcoat is actually closer to one millimeter (1 mm) or less in order to optimally preserve shape and appearance of the kernels of grain so as to make the animal feed product more attractive and more palatable to ruminant animals. The individual, discrete nature of the whole kernels of grain comprising the animal feed product makes the animal feed product easier to handle and disburse in typical animal feeder devices that are designed for feeding untreated grain foodstuffs to ruminants, for example, spinner feeders designed to disburse deer corn. The limitation on the thickness of the overcoat also makes the animal feed product easier to disburse in common feeder devices.

While the animal feed product is comprised of multiple, discrete, whole or partial kernels of grain that are wholly or partially coated with an overcoat, the type of grain may be any suitable grain and may be selected from the list including corn, cottonseed, barley, rye, wheat, oats, lupins, sourgham, soybeans, or millet. Furthermore, although the kernels of grain in the animal feed product may all be one type of grain selected from the above list, such as all kernels of corn in the preferred embodiment, in alternative embodiments the animal feed product may be comprised of a mixture of more than one type of kernels of grain selected from the above list, such as a mixture of corn kernels and soybean kernels that have been wholly or partially coated with an overcoat.

The overcoat adhered to the outside surface of the discrete, whole or partial kernels of grain comprising the animal feed product may be comprised of any one or more of the following categories of substances: 1) a sweetener; 2) a binding agent; 3) desired vitamins and minerals; 4) a drying agent; 5) ruminant attractant; 6) preservatives; 7) anti-molding agent; 9) coloring; 10) added fat; 11) added protein; or 12) flavoring.

The sweeteners that are possible candidates for inclusion in the overcoat can be a sugar such as cane sugar, molasses, or other readily available sugars such as raw sugar (sucrose), dextrose, glucose, fructose, sorbitol or lactose, or possibly another natural sweetener such as a corn sweetener, corn syrup, agave nectar, honey, xylitol, mannitol, or stevia leaf extract. These sugars and natural sweeteners would not only make the animal feed product more palatable to ruminants, but they also increase the nutritional carbohydrate value of the animal feed product. Alternatively, there are a variety of artificial sweeteners that could be used as a sweetener in the overcoat instead of a natural sugar such as saccharin, sucralose, neotame, aspartame, or acelsulfame potassium. It should be understood that a number of different natural and artificial sweeteners could be used as a sweetener in the overcoat, and the above listed sweeteners are listed by way of example only. In the preferred embodiment of the animal feed product, molasses is used as a sweetener in the overcoat. Molasses increases the palatability of the animal feed product, is a good source of carbohydrate for ruminant animals, and improves rumen microbial activity. The molasses in this embodiment can be any type of molasses, including but not limited to cane molasses, beet molasses, starch molasses, citrus molasses, or hemicellulose extract.

There are a number of binding agents that are candidates for inclusion in the overcoat, and such binding agents can be any one of multiple known binding agents that would serve to bind or adhere the overcoat to the kernels of grain, for example, flour could potentially be used as a binding agent. However, many of the potential sweeteners that could be used in the overcoat will also act as a binding agent that binds or adheres the overcoat to the surface of the kernels of grain such that in some embodiments the sweetener in the overcoat will also serve as the binding agent. Examples of proposed sweeteners that could serve as both a sweetener and as a binding agent in the overcoat include cane sugar, molasses, raw sugar (sucrose), dextrose, glucose, fructose, sorbitol, lactose, corn sweetener, corn syrup, agave nectar, honey, xylitol, mannitol, or stevia leaf extract. It will be understood that a number of additional binding agents could be used in the overcoat without departing from the scope of the invention. In the preferred embodiment, molasses serves as both the sweetener and the binding agent in the overcoat. As previously discussed, the molasses in the preferred embodiment can be any type of molasses, including but not limited to cane molasses, beet molasses, starch molasses, citrus molasses, or hemicellulose extract.

There are a number of drying agents that are candidates for inclusion in the overcoat, and drying agents that may be included in the overcoat may be any compound that is capable of absorbing moisture during the process of creating and storing the animal feed product. For example, the drying agent could be a suitable oxide, carbonate, choloride, or sulphate of magnesium, calcium, sodium, zinc, copper, manganese or cobalt. It will be appreciated that there are other drying agents that are possible candidates for use in the nutritional overcoat. In the preferred embodiment, the drying agent in the nutritional overcoat is an oxide of an alkaline earth metal, such as either magnesium oxide or calcium oxide. Magnesium oxide or calcium oxide are both advantageous because they can serve not only as a drying agent in the nutritional overcoat, but they also aid in the binding or adhering of the nutritional overcoat to the whole kernels or partial kernels of grain. Moreover, the presence of magnesium oxide or calcium oxide as the drying agent in the nutritional overcoat will also serve as a nutrient mineral for the ruminant animal.

There are also many vitamins, macro minerals and trace minerals that are candidates for inclusion in the overcoat, several of which are known to promote growth and overall health of ruminant animals. The vitamins and minerals included in the overcoat may be any desired, commercially available pre-mix of vitamins and minerals in powdered or granular form that is sold for use in the feeding and nutrition of ruminants. When not using a commercially available pre-mix of vitamins and minerals, one or more vitamins may be selected for inclusion or considered for inclusion in the overcoat, for example, Vitamin A, Vitamin D, and Vitamin E have traditionally been used to supplement ruminant nutrition. One or more macro minerals may be selected for inclusion in the overcoat, for example, calcium, phosphorous, potassium, magnesium, sodium, and sulfur are each candidates for inclusion in the overcoat. Additionally, one or more trace minerals may be selected for inclusion in the overcoat, such as copper, iron, zinc, manganese, cobalt, iodine or selenium. Any one or more of these above-listed vitamins, macro minerals, and trace minerals may be included within the overcoat without departing from the scope of the invention. It should also be appreciated that different vitamins and minerals other than those listed above could be used in the overcoat without departing from the scope of the invention.

There are several ruminant attractants that are candidates for inclusion in the overcoat, including commonly used ruminant attractants such as apple flavoring, brewer's grain, green apple, peanut butter, persimmon, red delicious apple, or white oak acorn. Moreover, the presence of molasses in the overcoat may serve not only as a potential binder and sweetener, but is also a ruminant attractant. It will be appreciated that there are other commercially available products marketed specifically as ruminant attractants that may be added in powder, granular, meal, or liquid form to the materials comprising the overcoat that could serve as the ruminant attractant in the overcoat. In the preferred embodiment, molasses is used as a ruminant attractant in the nutritional overcoat. Molasses is advantageous because it serves not only as a ruminant attractant in the overcoat, but also serves as a sweetener, a nutritional supplement, and an aid in the binding or adhering of the overcoat to the whole kernels or partial kernels of grain.

There are several candidates for added fat and added protein for inclusion in the overcoat, including soybean mean, soybean oil, cottonseed meal, cottonseed oil, sunflower meal, sunflower oil. The best source of added fat and protein appears to be soybean meal or soybean powder. The primary benefit of including soybean meal or soybean powder in the overcoat is that it adds additional protein that is valuable in the nutrition of ruminant animals and supplements that inherent protein content of the kernel of grain itself. In one embodiment, soybean mean is ground down to powder form and mixed with molasses and whole kernels of corn such that an overcoat of molasses and soybean powder is adhered to the surface of the kernels of corn.

In all embodiments of the animal feed product, the multiple kernels of grain that are wholly or partially coated with the overcoat are intended to remain discrete kernels of grain, and they are not intentionally bound together in rigid form, nor have the kernels been ground or processed into pelletized animal feed. However, despite the fact that the animal feed product is intended to be comprised of multiple discrete whole or partial kernels of grain that are wholly or partially coated with a nutritional overcoat, in practice there may be a small, non-zero percentage of the kernels of grain that are adhered or “clumped” together in small clumps. This is unintentional, and steps are taken in the preparation of the animal feed product in order to prevent such clumps from forming, such as utilizing a grain dryer to dry the overcoats on the discrete kernels of grain after the initial mixing phase before clumping can occur, or using a tumbling device or agitator to tumble, shake or otherwise agitate the animal feed product after application of the overcoat and after drying in order to break apart such clumps that may have formed. Despite these steps, the possibility still exists that some clumps involving multiple kernels bound together may exist in the final animal feed product, but the majority of the animal feed product is comprised of discrete whole or partial kernels of grain that are wholly or partially coated with an overcoat as described hereinabove. Furthermore, in practice is has been found that small clumps involving a few kernels of grain generally do not impair the ability to disburse the animal feed product through animal feeder devices such as spinner feeders for deer.

In one embodiment of the invention, the animal feed product is comprised of 77%-85% by weight whole or partial kernels of corn, 3%-9% by weight of molasses, 6%-7% by weight of selected vitamins and minerals, and 4%-9% by weight of magnesium oxide, wherein the molasses, selected vitamins and minerals, and magnesium oxide are mixed together in an overcoat that wholly or partially coats the surfaces of the discrete whole or partial kernels of corn such that the discrete whole or partial kernels of corn are wholly or partially coated with the overcoat.

In one embodiment of the invention, the animal feed product is comprised of 80%-85% by weight whole or partial kernels of corn, 4%-5% by weight of molasses, 4%-5% by weight of magnesium oxide, and 6%-7% by weight of selected vitamins and minerals, wherein the molasses, magnesium oxide, and vitamins and minerals are mixed together in an overcoat that wholly or partially coats the surfaces of the discrete whole or partial kernels of corn such that each of the discrete whole or partial kernels of corn are wholly or partially coated with the overcoat. In this embodiment, the vitamins and minerals in the nutritional overcoat comprise Vitamin A, Vitamin D, Vitamin E, calcium, phosphorous, potassium, magnesium, sodium, sulfur, copper, iron, zinc, manganese, cobalt, iodine and selenium.

In one embodiment of the invention, the animal feed product is comprised of 90%-93% by weight whole or partial kernels of corn, 1%-4% by weight of molasses, 1%-4% by weight of calcium carbonate, and 0.5%-3% by weight of magnesium oxide, wherein the molasses, calcium carbonate, and magnesium oxide are mixed together in an overcoat that and wholly or partially coats the surfaces of the discrete whole or partial kernels of corn such that the individual whole or partial kernels of corn are wholly or partially coated with the overcoat.

In one embodiment of the invention, the animal feed product is comprised of 44%-47% by weight whole or partial kernels of corn, 44%-47% by weight whole or partial soybean kernels, 1%-6% by weight of molasses, 2%-3% by weight of calcium carbonate, and 1%-3% by weight of magnesium oxide, wherein the molasses, calcium carbonate, and magnesium oxide are mixed together in an overcoat that wholly or partially coats the surfaces of the discrete whole or partial kernels of corn such that the discrete whole or partial kernels of corn are wholly or partially coated with the overcoat.

The preparation of the animal feed product may be accomplished by mixing whole or partial kernels of grain together with the substances selected for inclusion in the overcoat, preferably at a temperature in the range of 30-120 degrees Fahrenheit.

The preparation of the animal feed product may be accomplished by mixing whole or partial kernels of grain together with the substances selected for inclusion in the overcoat, preferably at a temperature in the range of 30-120 degrees Fahrenheit. The whole or partial kernels of grain will preferably be mixed with the substances selected for inclusion in the overcoat until the discrete whole or partial kernels of grain are wholly or partially covered with the nutritional overcoat. Mixing of the whole or partial kernels of grain will continue until the overcoat is bound or adhered to the surface of the discrete whole or partial kernels of grain such that the discrete whole or partial kernels of grain are wholly or partially covered with the overcoat.

The preparation of the animal feed product may be accomplished by mixing whole kernels or partial kernels of grain together with the overcoat elements, preferably at a temperature in the range of 30-120 degrees Fahrenheit. The whole kernels or partial kernels of grain will be mixed with the overcoat elements until the discrete whole or partial kernels of grain are wholly or partially covered with the overcoat elements forming an overcoat on all or part of the surfaces of each discrete kernel of grain. The mixing of the whole or partial kernels of grain will continue until the overcoat is bound or adhered to the discrete whole kernels or partial kernels of grain and such that the resulting animal feed product is not wet or oily in appearance or to the touch.

The preparation of the animal feed product may also be accomplished by mixing whole kernels or partial kernels of grain together with the overcoat elements, preferably at a temperature in the range of 30-120 degrees Fahrenheit. The whole kernels or partial kernels of grain will be mixed with the overcoat elements until the discrete whole or partial kernels of grain are wholly or partially coated with the overcoat elements forming an overcoat on all or part of the surfaces of each discrete kernel of grain. The initial mixing of the whole or partial kernels of grain with the overcoat elements may be followed by a drying period in which the overcoat that wholly or partially covers the discrete kernels of grain is allowed to dry. The length of this drying period may vary, but it will last as long as necessary for the animal feed product to lose any oily appearance and to appear dry according to visual observation.

The preparation of the animal feed product may further be accomplished by mixing whole kernels or partial kernels of grain together with the overcoat elements, preferably at a temperature in the range of 30-120 degrees Fahrenheit. The whole kernels or partial kernels of grain will be mixed with the overcoat elements until the discrete whole or partial kernels of grain are wholly or partially coated with the overcoat elements forming an overcoat that coats all or part of the surfaces of each discrete kernel of grain. The initial mixing of the whole or partial kernels of grain with the overcoat elements may be followed by a drying period in which the overcoat that wholly or partially covers the discrete whole or partial kernels of grain is allowed to dry. The length of this drying period may vary, but it will last as long as necessary for the animal feed product to lose any oily appearance and to appear dry according to visual observation. Drying of the animal feed product may be accomplished by either spreading the animal feed product out and then air-drying or using a grain dryer to accelerate the drying process. The drying period may also be followed by a tumbling or agitation process in which the animal feed product is run through a mixing machine, a tumbling machine, a vibrating or shaking machine, or other similar mechanical device that tumbles, shakes, or agitates the animal feed product in a manner that causes clumps of multiple kernels of coated grain to break apart such that the majority of the animal feed product will be comprised of discrete whole or partial kernels of grain with a partial or whole overcoat that are not clumped together with other coated kernels.

The preparation of the animal feed product may also be accomplished by mixing whole kernels or partial kernels of grain together with molasses and calcium carbonate initially, and subsequently with magnesium oxide, all preferably at a temperature in the range of 30-120 degrees Fahrenheit. The whole kernels or partial kernels of grain will be mixed initially with the molasses and the calcium carbonate, and then the magnesium oxide will be added in and mixed until the individual, discrete whole or partial kernels of grain are wholly or partially coated with an overcoat comprised of molasses, calcium carbonate, and magnesium oxide that coats all or part of the surfaces of each discrete kernel of grain in the animal feed product. The initial mixing of the whole or partial kernels of grain with the molasses, calcium carbonate, and magnesium oxide may be followed by a drying period in which the overcoat that wholly or partially covers the discrete kernels of grain is allowed to dry. The length of this drying period may vary, but it will typically last as long as necessary for the animal feed product to lose any oily appearance and to appear dry according to visual observation.

The preparation of the animal feed product may also be accomplished by mixing whole kernels or partial kernels of grain together with molasses and calcium carbonate initially, and subsequently with magnesium oxide, all at a temperature in the range of 30-120 degrees Fahrenheit. The whole kernels or partial kernels of grain will be mixed with the molasses, calcium carbonate, and then the magnesium oxide until the discrete whole or partial kernels of grain are wholly or partially coated with an overcoat comprised of molasses, calcium carbonate, and magnesium oxide that coats all or part of the surfaces of each discrete kernel of grain making up the animal feed product. The initial mixing of the whole or partial kernels of grain with the molasses, calcium carbonate, and subsequent addition of the magnesium oxide may be followed by a drying period in which the overcoat that wholly or partially covers the discrete kernels of grain is allowed to dry. The length of this drying period may vary, but it will typically last as long as necessary for the animal feed product to lose any oily appearance and to appear dry according to visual observation. The drying period may also be followed by a tumbling or agitation process in which the animal feed product is run through a mixing machine, a tumbling machine, a vibrating or shaking machine, or other similar mechanical device that tumbles or shakes the animal feed product in a manner that causes clumps of multiple kernels of grain to break apart such that the majority of the animal feed product will be comprised of discrete whole or partial kernels of grain with a partial or whole overcoat at the end of the process.

The various embodiments of the animal feed product described above may further be mixed with additional untreated kernels of grain (kernels of grain that do not have an overcoat adhered on their surfaces) without departing from the scope of this invention. This may be done in order to facilitate ease of disbursement of the animal feed product through ruminant feeding devices such as spin feeders for deer. The animal feed product embodiments described herein are readily capable of being spread or disbursed through such devices, but the mixture of untreated kernels of grain with the animal feed product often increases the rate of such disbursement or spreading of the animal feed product through ruminant animal feeder devices, such as spin feeders for deer. In other words, each of the embodiments of the animal feed product as set forth herein could be further mixed with untreated whole or partial kernels of corn, soybean, cottonseed, or other type of grain that do not have an overcoat without departing from the scope of this invention.

With regard to facilitating ease of disbursement of the animal feed product through animal feeder devices, the use of untreated kernels of corn is helpful in this regard. In an embodiment of the invention that seems to work very well in spin feeders for deer, the amount of untreated corn to animal feed product appears to be approximately 20%-30% untreated corn or field corn, and 70% to 80% animal feed product in which the kernels of grain are partially or wholly coated with an overcoat. The inventor has also attained satisfactory results with an animal feed product comprised of 70-90% by weight whole or partial kernels of corn that are wholly or partially coated with an overcoat mixed with 10-30% by weight uncoated soybeans. This type of mixture of kernels of corn bearing an overcoat with soybean kernels that do not have an overcoat has proved satisfactory for the purposes set forth herein.

Each of the embodiments of the invention discussed herein may be further supplemented by adding an additional protein source such as cottonseed meal/flour or soybean meal/four to the overcoat mixture at the time the product is initially mixed and prior to the drying step.

It should be understood that the above-described embodiments of the invention are not intended to limit the scope of the invention, but merely to illustrate specific embodiments of the animal feed product as envisioned by the inventor at the time of filing of his application for patent.

### DESCRIPTION OF THE PREFERRED EMBODIMENT

In the preferred embodiment of the animal feed product, the animal feed product is comprised of whole kernels of corn that are wholly coated with a nutritional overcoat that is comprised of molasses, magnesium oxide, calcium oxide and vitamins and minerals, including Vitamin A, Vitamin D, Vitamin E, phosphorous, potassium, sodium, sulfur, copper, iron, zinc, manganese, cobalt, iodine and selenium.

What I claim is:

1. An animal feed product comprised of:
discrete, whole or partial kernels of grain that are wholly or partially coated with an overcoat.

2. The animal feed product of claim 1, wherein the overcoat is comprised of a sweetener.

3. The animal feed product of claim 2, wherein the overcoat is additionally comprised of a drying agent.

4. The animal feed product of claim 3, wherein the overcoat is additionally comprised of selected vitamins and minerals.

5. The animal feed product of claim 4, wherein the overcoat is additionally comprised of a binding agent.

6. The animal feed product of claim 5, wherein the overcoat is additionally comprised of a ruminant attractant.

7. The animal feed product of claim 6, wherein the overcoat is additionally comprised of added fat and protein.

8. The animal feed product of claim 7, wherein the overcoat is additionally comprised of a preservative or anti-molding agent.

9. The animal feed product of claim 1, wherein the kernels of grain are selected from one or more of the following types of grain: corn, cottonseed, barley, rye, wheat, oats, lupins, sourgham, soybeans, or millet.

10. The animal feed product of claim 1, wherein the overcoat is comprised of a binding agent.

11. The animal feed product of claim 10, wherein the binding agent is selected from one or more of the following types of binding agents: flour, refined sugar, raw sugar, glucose, mannose, fructose, maltose, molasses, molasses extract, cane sugar, or cane sugar extract.

12. The animal feed product of claim 1, wherein the overcoat is comprised of vitamins and minerals.

13. The animal feed product of claim 12, wherein the vitamins and minerals are selected from one or more of the following vitamins and minerals: Vitamin A, Vitamin D, Vitamin E, calcium, phosphorous, potassium, magnesium, sodium, sulfur, copper, iron, zinc, manganese, cobalt, iodine and selenium.

14. The animal feed product of claim 1, wherein the overcoat is comprised of a sweetener.

15. The animal feed product of claim 14, wherein the sweetener is selected from one or more of the following sweeteners: cane sugar, cane sugar extract, molasses, molasses extract, refined sugar, raw sugar, dextrose, glucose, mannose, fructose, maltose, sorbitol, lactose, or corn sweetener.

16. The animal feed product of claim 1, wherein the overcoat is comprised of a drying agent.

17. The animal feed product of claim 16, wherein the drying agent is an oxide, carbonate, chloride, or sulphate of magnesium, calcium, sodium, zinc, copper, manganese or cobalt.

18. The animal feed product of claim 1, wherein the overcoat is comprised of a ruminant attractant.

19. The animal feed product of claim 18, wherein the ruminant attractant is selected from one of the following: apple flavoring, brewer's grain, green apple, peanut butter, persimmon, red delicious apple, or white oak acorn.

20. An animal feed product comprised of:
a whole kernel of corn that is wholly coated with an overcoat comprised of molasses that is coated on the outside surface of the kernel of corn.

21. The animal feed of claim 20, wherein the overcoat is further comprised of calcium oxide.

22. The animal feed of claim 20, wherein the overcoat is further comprised of magnesium oxide.

23. The animal feed of claim 20, wherein the overcoat is further comprised of Vitamin A, Vitamin D, Vitamin E, calcium, phosphorous, potassium, magnesium, sodium, sulfur, copper, iron, zinc, manganese, cobalt, iodine and selenium.

24. The animal feed of claim 20, wherein the overcoat is further comprised of a ruminant attractant such as apple flavoring, brewer's grain, green apple, peanut butter, persimmon, red delicious apple, or white oak acorn.

25. A method of preparing an animal feed product comprised of the following steps:
Mixing whole kernels of grain with selected substances chosen for inclusion in an overcoat that will coat the outside surfaces of the whole kernels, wherein the mixing occurs at 30-120 degrees Fahrenheit and the mixing results in the majority of the outside surfaces of the kernels of grain being coated with an overcoat comprised of the selected substances;
Drying the kernels of grain that are wholly or partially coated with the overcoat of selected substances until the overcoat is not wet or oily in appearance or to the touch.

26. The method of claim 25, wherein the preparation of the animal feed product involves the additional step of using a mixing machine, a tumbling machine, a vibrating or shaking machine, or other similar mechanical device that tumbles, shakes, or agitates the animal feed product in a manner that causes clumps of multiple kernels of coated grain to break apart such that the majority of the resulting animal feed product will be comprised of discrete whole or partial kernels of grain with a partial or whole overcoat that are not clumped together with other coated kernels.

27. The method of claim 25, wherein the preparation of the animal feed product involves the additional step of passing the coated kernels of grain over a screen having mesh of a diameter no smaller than 2 mm and no larger than 5 mm in any direction which will allow many small partial kernels of grain that are less than fifty-percent of the size of a full kernel of grain to be separated from larger whole or partial kernels of grain thereby eliminating most small partial kernels of grain from the resulting animal feed product.
